(19) United States
(12) Patent Application Publication
(10) Pub. No.: US 2006/0126004 A1
(43) Pub. Date: Jun. 15, 2006

(54) Thin film transistor array panel and repairing method therefor

(75) Inventors: Hyun-Wuk Kim, Gyeonggi-do (KR); Jun-Woo Lee, Gyeonggi-do (KR); Dong-Hoon Chung, Gyeonggi-do (KR); Yoon-Sung Um, Gyeonggi-do (KR); Jae-Jin Lyu, Gyeonggi-do (KR); Chang-Hun Lee, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/300,320

(22) Filed: Dec. 13, 2005

(30) Foreign Application Priority Data
Dec. 14, 2004 (KR) 10-2004-0105551

(51) Int. Cl. G02F 1/13

(52) U.S. Cl. 349/192

(57) ABSTRACT

A method of repairing a thin film transistor array panel is provided. The thin film transistor array panel includes a gate line, a data line intersecting the gate line, a thin film transistor connected to the gate line and the data line and having a drain electrode, a pixel electrode including at least one first subpixel electrode connected to the drain electrode of the thin film transistor and a second subpixel electrode capacitively coupled to the at least one first subpixel electrode. The repairing method according to an embodiment of the present invention includes: disconnecting at least one of the second subpixel electrode and the at least one first subpixel electrode from the thin film transistor.

### BACKGROUND OF THE INVENTION

(a) Field of the Invention

The present invention relates generally to liquid crystal displays. More specifically, the present invention relates to a thin film transistor array panel and a repair method therefor.

(b) Description of the Related Art

A liquid crystal display (LCD) is one of the most widely used flat panel displays. An LCD includes two panels provided with field-generating electrodes such as pixel electrodes and a common electrode, with a liquid crystal (LC) layer interposed therebetween. The LCD displays images by applying voltages to the field-generating electrodes, thus inducing an electric field in the LC layerthat determines orientations of LC molecules in the LC layer to adjust polarization of incident light.

Among the LCDs, a vertical alignment (VA) mode LCD, which aligns LC molecules such that the long axes of the LC molecules are perpendicular to the panels in the absence of an electric field, is often preferable for its high contrast ratio and wide reference viewing angle.

This wide viewing angle can be realized by employing cutouts in, and protrusions on, the field-generating electrodes. Since the cutouts and protrusions can determine the tilt directions of the LC molecules, the tilt directions can be distributed into several directions by using the cutouts and the protrusions such that the reference viewing angle is widened.

However, such LCD panels are not without drawbacks. For example, VA mode LCDs have poor lateral visibility as compared with frontal visibility, and can have defects such as white defects, or pixels that constantly shine bright white, distracting from the LCD panel's image.

### SUMMARY OF THE INVENTION

In one embodiment of the invention, a method of repairing a thin film transistor array panel is provided. The thin film transistor array panel includes a gate line, a data line intersecting the gate line, a thin film transistor connected to the gate line and the data line and having a drain electrode, a pixel electrode including at least one first subpixel electrode connected to the drain electrode of the thin film transistor and a second subpixel electrode capacitively coupled to the first subpixel electrode. The repairing method according to an embodiment of the present invention includes: disconnecting at least one of the second subpixel electrode and the at least one first subpixel electrode from the thin film transistor.

A thin film transistor array panel according to another embodiment of the present invention includes: a gate line; a data line intersecting the gate line; a thin film transistor connected to the gate line and the data line and including a drain electrode; and a pixel electrode including at least one first subpixel electrode connected to the drain electrode of the thin film transistor and a second subpixel electrode capacitively coupled to the first subpixel electrode, wherein the pixel electrode has a cutout for partitioning the pixel electrode into at least two partitions and the cutout overlaps the drain electrode and has a width of the cutout larger at the overlap.

### BRIEF DESCRIPTION OF THE DRAWINGS

The present invention will become more apparent by describing embodiments thereof in detail with reference to the accompanying drawings in which:

FIG. 1 is a layout view of a TFT array panel of an LCD according to an embodiment of the present invention;

FIG. 2 is a layout view of a common electrode panel of an LCD according to an embodiment of the present invention;

FIG. 3 is a layout view of an LCD including the TFT array panel shown in FIG. 1 and the common electrode panel shown in FIG. 2;

FIG. 4 is a sectional view of the LCD shown in FIG. 3 taken along line IV-IV′;

FIG. 5 is an equivalent circuit diagram of the LCD shown in FIGS. 14;

FIG. 6 is a layout view of an LCD according to another embodiment of the present invention;

FIG. 7 is a sectional view of the LCD shown in FIG. 6 taken along line VII-VII′;

FIG. 8 is an sectional view of the LCD shown in FIG. 3 taken along line IV-IV′; and

FIG. 9 is a layout view of an LCD according to another embodiment of the present invention.

### DETAILED DESCRIPTION OF EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

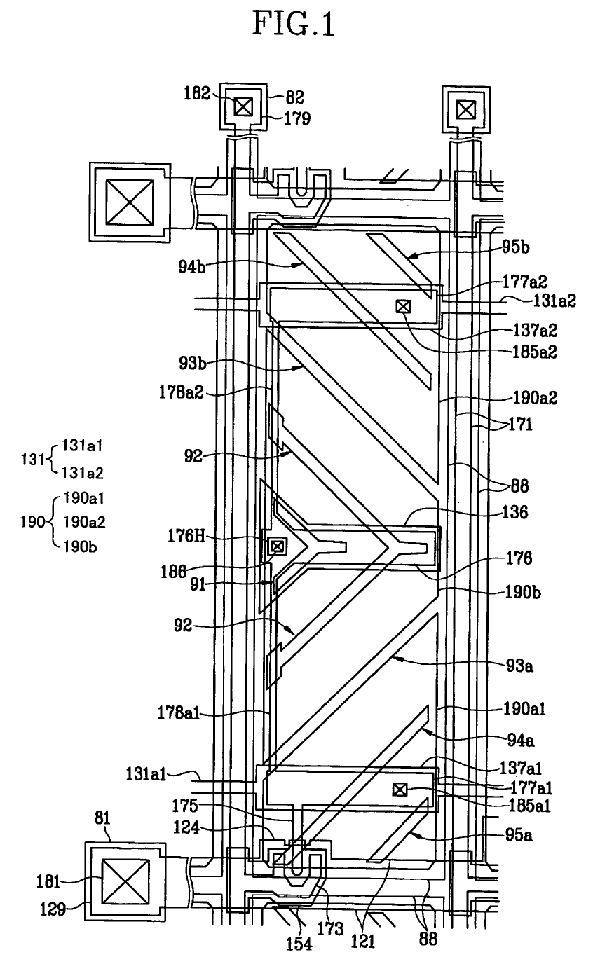

An LCD according to an embodiment of the present invention will be described in detail with reference to FIGS. 1-5.

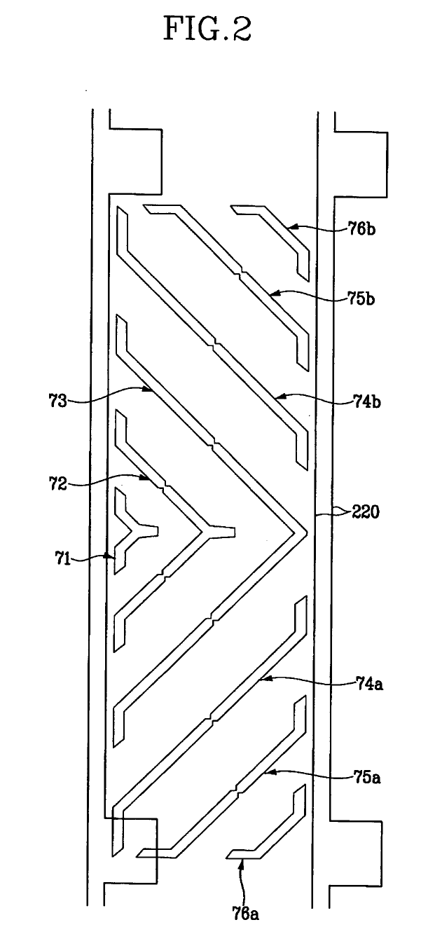

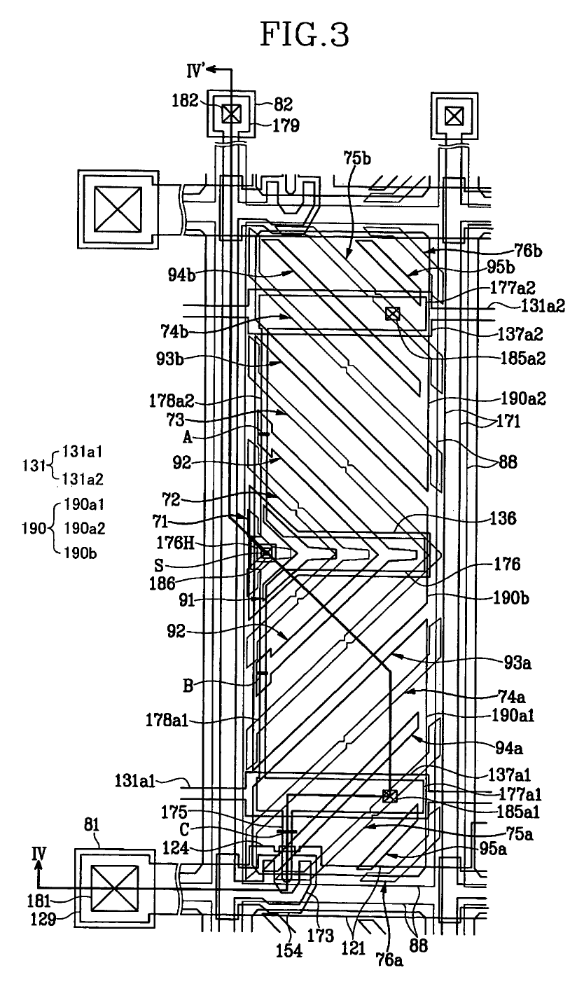

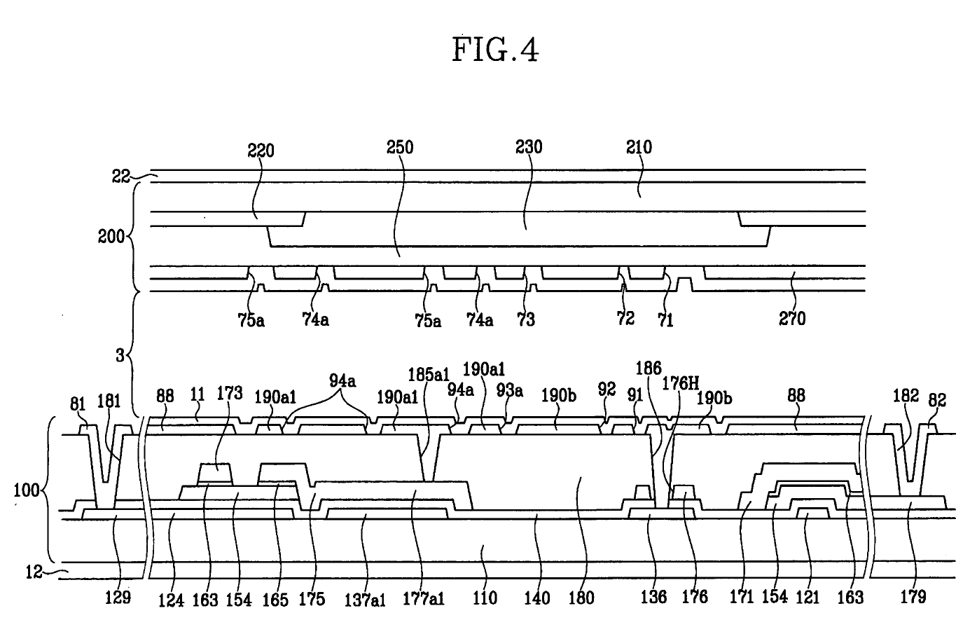

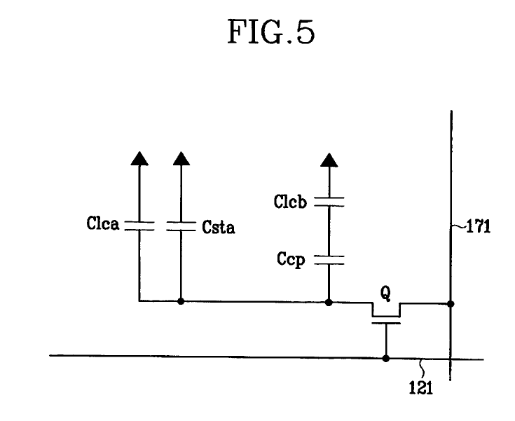

FIG. 1 is a layout view of a TFT array panel of an LCD according to an embodiment of the present invention. FIG. 2 is a layout view of a common electrode panel of an LCD according to an embodiment of the present invention. FIG. 3 is a layout view of an LCD including the TFT array panel shown in FIG. 1 and the common electrode panel shown in FIG. 2. FIG. 4 is a sectional view of the LCD shown in FIG. 3 taken along line IV-IV′, and FIG. 5 is an equivalent circuit diagram of the LCD shown in FIGS. 1-4.

Referring to FIGS. 1-4, an LCD according to an embodiment of the present invention includes a TFT array panel 100, a common electrode panel 200, and an LC layer 3 interposed between the panels 100 and 200.

The TFT array panel 100 is now described in detail with reference to FIGS. 1, 3 and 4.

A plurality of gate conductors including a plurality of gate lines 121, a plurality of storage electrode lines 131, and a plurality of capacitive electrodes 136 are formed on an insulating substrate 110 such as transparent glass or plastic.

The gate lines 121 transmit gate signals and extend substantially in a transverse direction. Each gate line 121 includes a plurality of gate electrodes 124 projecting upward and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated onto the substrate 110. The gate lines 121 may extend to be connected to a driving circuit that may be integrated on the substrate 110.

The storage electrodes 131 are supplied with a predetermined voltage and each of the storage electrodes 131 includes a pair of lower and upper stems 131a1 and 131a2 extending substantially parallel to the gate lines 121. Each of the storage electrode lines 131 is disposed between two adjacent gate lines 121, and the lower and the upper stems 131a1 and 131a2 are disposed close to lower and upper ones of the two adjacent gate lines 121, respectively. The lower and the upper stems 131a1 and 131a2 include lower and upper storage electrodes 137a1 and 137a2, respectively, expanding upward and downward. However, the storage electrode lines 131 may have various shapes and arrangements.

Each of the capacitive electrodes 136 is a rectangle elongated parallel to the gate lines 121 and separated from the gate lines 121 and the storage electrode lines 131. Each of the capacitive electrodes 136 is disposed between a pair of lower and upper storage electrodes 137a1 and 137a2 and is substantially equidistant from the lower and the upper storage electrodes 137a1 and 137a2 and from the adjacent two gate lines 121. Each of the capacitive electrodes 136 includes a funneled left end portion that has oblique edges making about 45 degrees with the gate lines 121.

The gate conductors 121, 131 and 136 are preferably made of metal such as Al containing metal such as Al and Al alloy, Ag containing metal such as Ag and Ag alloy, Cu containing metal such as Cu and Cu alloy, Mo containing metal such as Mo and Mo alloy, Cr, Ta, or Ti. However, they may have a multi-layered structure including two conductive films (not shown) having different physical characteristics. One of the two films is preferably made of low resistivity metal including Al containing metal, Ag containing metal, and Cu containing metal for reducing signal delay or voltage drop. The other film is preferably made of material such as Mo containing metal, Cr, Ta, or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. However, the gate conductors 121, 131 and 136 may be made of various metals or conductors.

The lateral sides of the gate conductors 121, 131 and 136 are inclined relative to a surface of the substrate 110, and the inclination angle thereof ranges about 30-80 degrees.

A gate insulating layer 140 preferably made of silicon nitride (SiNx) or silicon oxide (SiOx) is formed on the gate conductors 121, 131 and 136.

A plurality of semiconductor islands 154 preferably made of hydrogenated amorphous silicon (abbreviated to “a-Si”) or polysilicon are formed on the gate insulating layer 140. The semiconductor islands 154 are disposed on the gate electrodes 124 and include extensions covering edges of the gate lines 121. A plurality of other semiconductor islands (not shown) may be disposed on the storage electrode lines 131.

A plurality of ohmic contact islands 163 and 165 are formed on the semiconductor stripes 154. The ohmic contacts 163 and 165 are preferably made of n+ hydrogenated a-Si heavily doped with n type impurity such as phosphorous or they may be made of silicide. The ohmic contacts 163 and 165 are located in pairs on the semiconductor islands 154.

The lateral sides of the semiconductor islands 154 and the ohmic contacts 163 and 165 are inclined relative to the surface of the substrate 110, and the inclination angles thereof are preferably in a range of about 30-80 degrees.

A plurality of data conductors including a plurality of data lines 171 and a plurality of drain electrodes 175 are formed on the ohmic contacts 163 and 165 and the gate insulating layer 140.

The data lines 171 transmit data signals and extend substantially in the longitudinal direction to intersect the gate lines 121 and the storage electrode lines 131. Each data line 171 includes a plurality of source electrodes 173 projecting toward the gate electrodes 124 and an end portion 179 having a large area for contact with another layer or an external driving circuit. A data driving circuit (not shown) for generating the data signals may be mounted on a FPC film (not shown), which may be attached to the substrate 110, directly mounted on the substrate 110, or integrated onto the substrate 110. The data lines 171 may extend to be connected to a driving circuit that may be integrated on the substrate 110.

Each of the drain electrodes 175 is separated from the data lines 171 and includes an end portion disposed opposite the source electrodes 173 with respect to the gate electrodes 124. The end portion is partly enclosed by a source electrode 173 that is curved like a character U.

Each drain electrode 175 further includes lower, upper, and central expansions 177a1, 177a2, and 176 and a pair of interconnections 178a1 and 178a2 connecting the expansions 177a1, 177a2, and 176. Each of the expansions 177a1, 177a2, and 176 is a rectangle elongated parallel to the gate lines 121 and the interconnections 178a1 and 178a2 connect the expansions 177a1, 177a2, and 176 near left sides thereof and extend substantially parallel to the data lines 171.

The lower and upper expansions 177a1 and 177a2 overlap lower and upper storage electrodes 137a1 and 137a2, respectively.

The central expansion 176 overlaps a capacitive electrode 136 and it is referred to as a “coupling electrode.” The coupling electrode 176 has a through-hole 176H exposing a top surface of the gate insulating layer 140 near a left end portion and it has nearly the same shape as the capacitive electrode 136.

A gate electrode 124, a source electrode 173, and a drain electrode 175 along with a semiconductor island 154 form a TFT having a channel formed in the semiconductor island 154 disposed between the source electrode 173 and the drain electrode 175.

The data conductors 171 and 175 are preferably made of refractory metal such as Cr, Mo, Ta, Ti, or alloys thereof. However, they may have a multilayered structure including a refractory metal film (not shown) and a low resistivity film (not shown). Good examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data conductors 171 and 175 may be made of various metals or conductors.

The data conductors 171 and 175 have inclined edge profiles, and the inclination angles thereof range about 30-80 degrees.

The ohmic contacts 163 and 165 are interposed only between the underlying semiconductor islands 154 and the overlying data conductors 171 and 175 thereon and reduce the contact resistance therebetween. The extensions of the semiconductor islands 154 disposed on the edges of the gate lines 121 smooth the profile of the surface to prevent the disconnection of the data lines 171 there. The semiconductor islands 154 include some exposed portions, which are not covered with the data conductors 171 and 175, such as portions located between the source electrodes 173 and the drain electrodes 175.

A passivation layer 180 is formed on the data conductors 171 and 175, and the exposed portions of the semiconductor islands 154. The passivation layer 180 is preferably made of inorganic or organic insulator and it may have a flat surface. Examples of the inorganic insulator include silicon nitride and silicon oxide. The organic insulator may have photosensitivity and it preferably has dielectric constant less than about 4.0. The passivation layer 180 may include a lower film of inorganic insulator and an upper film of organic insulator such that it takes the excellent insulating characteristics of the organic insulator while preventing the exposed portions of the semiconductor islands 154 from being damaged by the organic insulator.

The passivation layer 180 has a plurality of contact holes 182 exposing the end portions 179 of the data lines 171 and a plurality of contact holes 185a1 and 185a2 exposing the lower and the upper expansions 177a1 and 177a2 of the drain electrodes 175, respectively. The passivation layer 180 and the gate insulating layer 140 have a plurality of contact holes 181 exposing the end portions 129 of the gate lines 121 and a plurality of contact holes 186 penetrating the through-holes 176H without exposing the coupling electrodes 176 and exposing the end portions of the capacitive electrodes 136. The contact holes 181, 182, 185a1, 185a2 and 186 may have inclined or stepped sidewalls that can be easily obtained by using organic material.

A plurality of pixel electrodes 190, a shielding electrode 88, and a plurality of contact assistants 81 and 82 are formed on the passivation layer 180. They are preferably made of transparent conductor such as ITO or IZO or reflective conductor such as Ag, Al, Cr, or alloys thereof.

Each pixel electrode 190 is approximately a rectangle having chamfered comers and the chamfered edges of the pixel electrode 190 make an angle of about 45 degrees with the gate lines 121. The pixel electrodes 190 overlap the gate lines 121 to increase the aperture ratio.

Each of the pixel electrodes 190 has lower and upper gaps 93a and 93b that divide the pixel electrode 190 into lower, upper, and central sub-pixel electrodes 190a1, 190a2 and 190b. The lower and the upper gaps 93a and 93b extend obliquely from a left edge to a right edge of the pixel electrode 190 such that the central sub-pixel electrode 190b is an isosceles trapezoid rotated by a right angle and the lower and the upper sub-pixel electrodes 190a1 and 190a2 are right-angled trapezoids rotated by a right angle. The lower and the upper gaps 93a and 93b make an angle of about 45 degrees with the gate lines 121 and they are perpendicular to each other.

The lower and the upper sub-pixel electrodes 190a1 and 190a2 are connected to the lower and the upper expansions 177a1 and 177a2 of the drain electrodes 175 through contact holes 185a1 and 185a2, respectively.

The central sub-pixel electrode 190b is connected to a capacitive electrode 136 through a contact hole 186 and overlaps a coupling electrode 176. The central sub-pixel electrode 190b, the capacitive electrode 136, and the coupling electrode 176 form a “coupling capacitor.”

The central sub-pixel electrode 190b has central cutouts 91 and 92, the lower sub-pixel electrode 190a1 has lower cutouts 94a and 95a, and the upper sub-pixel electrode 190a2 has upper cutouts 94b and 95b. The cutouts 91, 92 and 94a-95b partition the sub-pixel electrodes 190b, 190a1 and 190a2 into a plurality of partitions. The pixel electrode 190 having the cutouts 91, 92 and 94a-95b and the gaps 93a and 93b (also referred to as cutouts hereinafter) substantially has an inversion symmetry with respect to a capacitive electrode 136.

Each of the lower and the upper cutouts 94a-95b extends obliquely approximately from a left corner, a lower edge, or an upper edge of the pixel electrode 190 approximately to a right edge of the pixel electrode 190. The lower and the upper cutouts 94a-95b make an angle of about 45 degrees to the gate lines 121, and they extend substantially perpendicular to each other.

Each of the center cutouts 91 and 92 includes a transverse portion and a pair of oblique portions connected thereto. The transverse portion extends along the capacitive electrode 136, and the oblique portions extend obliquely from the transverse portion toward the left edge of the pixel electrode 190 in parallel to the lower and the upper cutouts 94a-95b, respectively. The center cutout 91 overlaps the funneled end portion of the coupling electrode 176 and the capacitive electrode 136. The oblique portions of the center cutout 92 include expanded end portions extending along the interconnections 178a and 178a2. The expanded end portions may have a width larger than other portions of the oblique portions of the center cutout 92, and it is preferable that the interconnections 178a and 178b are exposed through the expanded end portions of the oblique portions of the center cutout 92 for repairing.

The number of cutouts and partitions can vary depending on design factors such as the size of the pixel electrode 190, the ratio of the transverse edges and the longitudinal edges of the pixel electrode 190, the type and characteristics of the liquid crystal layer 3, and the like.

The shielding electrode 88 is supplied with the common voltage, and includes longitudinal portions extending along the data lines 171 and transverse portions extending along the gate lines 127 to connect adjacent longitudinal portions. The longitudinal portions fully cover the data lines 171, while each of the transverse portions lies within the boundary of a gate line 121.

The shielding electrode 88 blocks electromagnetic interference between the data lines 171 and the pixel electrodes 190 and between the data lines 171 and the common electrode 270 to reduce the distortion of the voltage of the pixel electrodes 190 and the signal delay of the data voltages carried by the data lines 171.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

The description of the common electrode panel 200 follows with reference to FIGS. 2-4.

A light blocking member 220, which can be referred to as a black matrix for preventing light leakage, is formed on an insulating substrate 210 such as transparent glass or plastic. The light blocking member 220 includes a plurality of rectilinear portions facing the data lines 171 on the TFT array panel 100 and a plurality of widened portions facing the TFTs on the TFT array panel 100. Otherwise, the light blocking member 220 may have a plurality of openings that face the pixel electrodes 190 and it may have substantially the same planar shape as the pixel electrodes 190.

A plurality of color filters 230 are also formed on the substrate 210 and they are disposed substantially in the areas enclosed by the light blocking member 220. The color filters 230 may extend substantially along the longitudinal direction along the pixel electrodes 190. The color filters 230 may represent one of the primary colors such as red, green and blue.

An overcoat 250 is formed on the color filters 230 and the light blocking member 220. The overcoat 250 is preferably made of (organic) insulator, and prevents the color filters 230 from being exposed, as well as providing a flat surface.

A common electrode 270 is formed on the overcoat 250. The common electrode 270 is preferably made of transparent conductive material such as ITO and IZO and has a plurality of sets of cutouts 71, 72, 73, 74a, 74b, 75a, 75b, 76a and 76b.

A set of cutouts 71-76b face a pixel electrode 190 and include center cutouts 71, 72 and 73, lower cutout 74a, 75a and 76a and upper cutouts 74b, 75b and 76b. The cutout 71 is disposed near the contact hole 186 and each of the cutouts 72-76b is disposed between adjacent cutouts 91-95b of the pixel electrode 190 or between a cutout 95a or 95b and a chamfered edge of the pixel electrode 190. Each of the cutouts 71-76b has at least an oblique portion extending parallel to the lower cutout 93a-95a or the upper cutout 93b-95b of the pixel electrode 190. Each of the oblique portions of the cutouts 72-75b has a depressed notch and the cutouts 71-76b have substantially an inversion symmetry with respect to a capacitive electrode 136.

Each of the lower and the upper cutouts 74a-76b includes an oblique portion and a pair of transverse and longitudinal portions or a pair of longitudinal portions. The oblique portion extends approximately from a left edge, a lower edge, or an upper edge of the pixel electrode 190 approximately to a right edge of the pixel electrode 190. The transverse and longitudinal portions extend from respective ends of the oblique portion along edges of the pixel electrode 190, overlapping the edges of the pixel electrode 190, and making obtuse angles with the oblique portion.

Each of the center cutouts 71 and 72 includes a central transverse portion, a pair of oblique portions, and a pair of terminal longitudinal portions and the center cutout 73 includes a pair of oblique portions and a pair of terminal longitudinal portions. The central transverse portion is disposed near the left edge or a center of the pixel electrode 190 and extends along the capacitive electrode 136. The oblique portions extend from an end of the central transverse portion or approximately from a center of the right edge of the pixel electrode 190, approximately to the left edge of the pixel electrode. The oblique portions of the cutouts 71 and 72 make oblique angles with the central transverse portion. The terminal longitudinal portions extend from the ends of the respective oblique portions along the left edge of the pixel electrode 190, overlapping the left edge of the pixel electrode 190, and making obtuse angles with the respective oblique portions.

The number of the cutouts 71-76b may be also varied depending on the design factors, and the light blocking member 220 may overlap the cutouts 71-76b to block the light leakage through the cutouts 71-76b.

Alignment layers 11 and 21 that may be homeotropic are coated on inner surfaces of the panels 100 and 200, and polarizers 12 and 22 are provided on outer surfaces of the panels 100 and 200 so that their polarization axes may be crossed and one of the polarization axes may be parallel to the gate lines 121. One of the polarizers 12 and 22 may be omitted when the LCD is a reflective LCD.

The LCD may further include at least one retardation film (not shown) for compensating the retardation of the LC layer 3. The retardation film has birefringence and gives a retardation opposite to that given by the LC layer 3.

The LCD may further include a backlight unit (not shown) supplying light to the LC layer 3 through the polarizers 12 and 22, the retardation film, and the panels 100 and 200.

It is preferable that the LC layer 3 has negative dielectric anisotropy and that the LC molecules in the LC layer 3 are aligned such that their long axes are substantially vertical to the surfaces of the panels 100 and 200 in the absence of an electric field. Accordingly, incident light cannot pass the crossed polarization system 12 and 22.

The opaque members such as the storage electrode lines 131, the capacitive electrodes 136, and the expansions 177a1, 177a2 and 176 and the interconnections 178a1 and 178a2 of the drain electrodes 175, and the transparent members such as the pixel electrodes 190 having the cutouts 91-95b and 71-76b are symmetrically arranged with respect to the capacitive electrodes 136 that are equidistant from adjacent gate lines 121. At this time, since the interconnections 178a1 and 178a2 are disposed near the edges of the pixel electrodes 190, they do not decrease the light transmissive areas, but rather block the texture generated near the light transmissive areas.

The LCD shown in FIGS. 14 is represented as an equivalent circuit in FIG. 5.

Referring to FIG. 5, a pixel of the LCD includes a TFT Q, a first subpixel including a first LC capacitor C_{LC}a and a storage capacitor C_{ST}, a second subpixel including a second LC capacitor C_{LC}b, and a coupling capacitor Ccp.

The first LC capacitor C_{LC}a includes lower and upper sub-pixel electrodes 190a1 and 190a2 as one terminal, the appropriate portion of the common electrode 270 as the other terminal, and a portion of the LC layer 3 disposed therebetween as a dielectric. Similarly, the second LC capacitor C_{LC}b includes a central sub-pixel electrode 190b as one terminal, the appropriate portion of the common electrode 270 as the other terminal, and a portion of the LC layer 3 disposed thereon as a dielectric.

The storage capacitor C_{ST} includes lower and upper expansions 177a1 and 177a2 of a drain electrode 175 as one terminal, lower and upper storage electrodes 137a1 and 137a2 as the other terminal, and a portion of the gate insulating layer 140 disposed therebetween as a dielectric. The coupling capacitor Ccp includes a central sub-pixel electrode 190b and a capacitive electrode 136 as one terminal, a coupling electrode 176 as the other terminal, and portions of the passivation layer 180 and the gate insulating layer 140 disposed therebetween as a dielectric.

The first LC capacitor C_{LC}a and the storage capacitor C_{ST} are connected in parallel to a drain of the TFT Q. The coupling capacitor Ccp is connected between the drain of the TFT Q and the second LC capacitor C_{LC}b. The common electrode 270 is supplied with a common voltage Vcom and the storage electrode lines 131 may be supplied with the common voltage Vcom.

The TFT Q applies data voltages from a data line 171 to the first LC capacitor C_{LC}a and the coupling capacitor Ccp in response to a gate signal from a gate line 121, and the coupling capacitor Ccp transmits the data voltage with a modified magnitude to the second LC capacitor C_{LC}b.

If the storage electrode line 131 is supplied with the common voltage Vcom and each of the capacitors C_{LC}a, C_{ST}, C_{LC}b and Ccp and the capacitance thereof are denoted as the same reference characters, the voltage Vb across the second LC capacitor C_{LC}b is given by:
Vb=Va×[Ccp/(Ccp+C_{LC}b)]
where Va denotes the voltage of the first LC capacitor C_{LC}a.

Since the term Ccp/(Ccp+C_{LC}b) is smaller than one, the voltage Vb of the second LC capacitor C_{LC}b is greater than that of the first LC capacitor C_{LC}a. This inequality may be also true when the voltage of the storage electrode line 131 is not equal to the common voltage Vcom.

When the potential difference is generated across the first LC capacitor C_{LC}a or the second LC capacitor C_{LC}b, an electric field substantially perpendicular to the surfaces of the panels 100 and 200 is generated in the LC layer 3. Accordingly, both the pixel electrode 190 and the common electrode 190 are hereinafter commonly referred to as field generating electrodes. When this substantially perpendicular field is generated, the LC molecules in the LC layer 3 tilt in response to the electric field such that their long axes are perpendicular to the field direction. The degree of tilt of the LC molecules determines the variation of the polarization of light incident on the LC layer 3, and this variation in the light polarization is transformed into variation of the light transmittance by the polarizers 12 and 22. In this way, the LCD displays images.

The tilt angle of the LC molecules depends on the strength of the electric field. Since the voltage Va of the first LC capacitor C_{LC}a and the voltage Va of the second LC capacitor C_{LC}b are different from each other, the tilt direction of the LC molecules in the first subpixel is different from that in the second subpixel and thus the luminances of the two subpixels are different. Accordingly, with maintaining the average luminance of the two subpixels in a target luminance, the voltages Va and Vb of the first and the second subpixels can be adjusted so that an image viewed from the side is close to an image viewed from the front, thereby improving the lateral visibility.

The ratio of the voltages Va and Vb can be adjusted by varying the capacitance of the coupling capacitor Ccp, and this coupling capacitance Ccp can be varied by changing the overlapping area and distance between the coupling electrode 176 and the central sub-pixel electrode 190b (and the capacitive electrode 136). For example, the distance between the coupling electrode 176 and the central sub-pixel electrode 190b becomes large when the capacitive electrode 136 is removed and the coupling electrode 176 is moved to the position of the capacitive electrode 136. Preferably, the voltage Vb of the second LC capacitor C_{LC}b is from about 0.6 to about 0.8 times the voltage Va of the first LC capacitor C_{LC}a.

The voltage Vb charged in the second LC capacitor C_{LC}b may be larger than the voltage Va of the first LC capacitor C_{LC}a. This can be realized by precharging the second LC capacitor C_{LC}b with a predetermined voltage such as the common voltage Vcom.

The ratio of the lower and the upper sub-pixel electrodes 190a1 and 190a2 of the first subpixel and the central sub-pixel electrode 190b of the second subpixel is preferably from about 1:0.85 to about 1:1.15 and the number of the sub-pixel electrodes in each of the LC capacitors C_{LC}a and C_{LC}b may be changed.

The tilt direction of the LC molecules is determined by a horizontal voltage component generated by the cutouts 91-95b and 71-76b of the field generating electrodes 190 and 270 and the oblique edges of the pixel electrodes 190 distorting the electric field, which is substantially perpendicular to the edges of the cutouts 91-95b and 71-76b and the oblique edges of the pixel electrodes 190. Referring to FIG. 3, a set of the cutouts 91-95b and 71-76b divides a pixel electrode 190 into a plurality of sub-areas each having two major edges. Since the LC molecules on each sub-area tilt perpendicular to the major edges, the azimuthal distribution of the tilt directions is limited to four directions, thereby increasing the reference viewing angle of the LCD.

In addition, when the areas that can transmit light for the above-described four tilt directions are the same, the visibility becomes better for various viewing directions. Since the opaque members are symmetrically arranged as described above, the adjustment of the transmissive areas is easy.

The notches in the cutouts 72-75b determine the tilt directions of the LC molecules on the cutouts 72-75b as above, and they may be provided at the cutouts 91-95b and may have various shapes and arrangements.

One of ordinary skill in the art will observe that the shapes and the arrangements of the cutouts 91-95b and 71-76b for determining the tilt directions of the LC molecules may be modified and at least one of the cutouts 91-95b and 71-76b can be substituted with protrusions (not shown) or depressions (not shown), while still achieving desirable results. The protrusions are preferably made of organic or inorganic material and disposed on or under the field-generating electrodes 190 or 270.

In the meantime, since there is no electric field between the shielding electrode 88 and the common electrode 270, the LC molecules on the shielding electrode 88 remain in their initial orientations blocking incident light incident. Accordingly, the shielding electrode 88 may serve as a light blocking member and the light blocking member 220 may be omitted.

In this configuration, assume that a capacitive electrode 136 or a central subpixel electrode 190b is short-circuited to a coupling electrode 176 of a drain electrode 175 at a point S as shown in FIG. 3. Then, the central subpixel electrode 190b is supplied with the same voltage as lower and upper subpixel electrodes 190a1 and 190a2 from the drain electrode 175 such that the pixel is brighter than its target luminance and than neighboring pixels. The result is a pixel referred to as a “white defect” which produces a white point that is often plainly visible (and is more dominant for low level grays).

In order to repair this white defect, an interconnection 178a2 is cut to disconnect the upper subpixel electrode 190a2 from the drain electrode 175, or an interconnection 178a1 is cut to disconnect the upper subpixel electrode 190a2 and the coupling electrode 176 from the drain electrode 175. Otherwise, a narrow end portion of the drain electrode 175 is cut to disconnect the lower and the upper subpixel electrodes 190a1 and 190a2 and the coupling electrode 176 from the TFT. Then, the disconnected portion(s) of the first subpixel has zero voltage, producing a “dark point.” Similarly, the second subpixel loses the voltage caused by capacitive coupling, also producing a dark point so that the pixel becomes darker and less recognizable.

FIG. 3 shows the cutting positions A, B and C for the above-described three cases. The cutting may be performed by a laser beam, and the cutting points A and B are located in wide end portions of a center cutout 92 for preventing the short circuit between the interconnections 178a2 and 178a1 and the central subpixel electrode 190b. The cutting points A or B are preferred for making the luminance of the repaired pixel close to a target luminance.

In other words, although all or some portions of a defected pixel may become dark after repairing, it is preferred that the dark portion is limited to only a part of the pixel rather than all of the pixel such that the repairing against the defect is less recognizable.

In another method for repairing white defects, all or some portions of the drain electrode 175 may be short-circuited to a storage electrode 131 with or without disconnecting the portions from the TFT or the drain electrode 175.

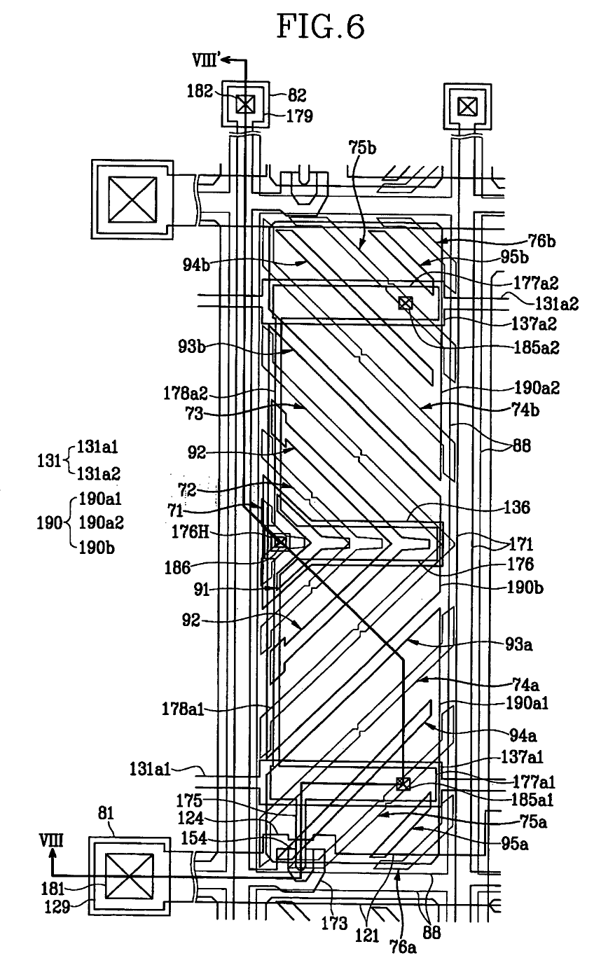

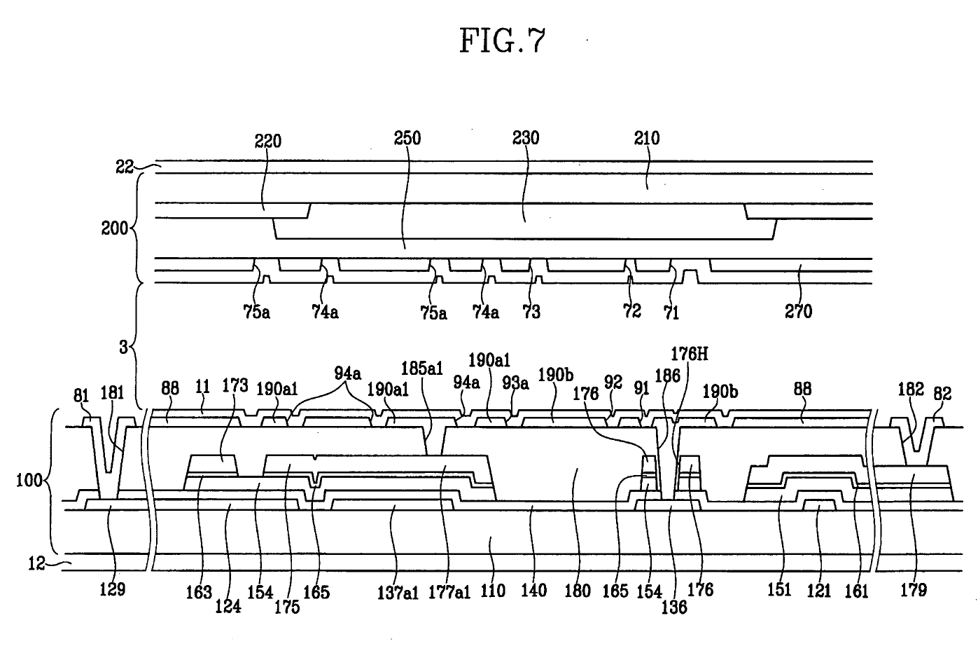

An LCD according to another embodiment of the present invention will be described in detail with reference to FIGS. 6 and 7.

FIG. 6 is a layout view of an LCD according to another embodiment of the present invention, and FIG. 7 is a sectional view of the LCD shown in FIG. 6 taken along line VII-VII′.

Referring to FIGS. 6 and 7, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are almost the same as those shown in FIGS. 14.

Regarding the TFT array panel 100, a plurality of gate lines 121 including gate electrodes 124 and end portions 129, a plurality of storage electrode lines 131 including stems 131a1 and 131a2 and storage electrodes 137a1 and 137a2, and a plurality of capacitive electrodes 136 are formed on a substrate 110. A gate insulating layer 140, a plurality of semiconductors 154, and a plurality of ohmic contacts 163 and 165 are sequentially formed on the gate lines 121 and the storage electrodes lines 131. A plurality of data lines 171 including source electrodes 173 and end portions 179 and a plurality of drain electrodes 175 including expansions 177a1, 177a2 and 176 and interconnections 178a1 and 178a2 are formed on the ohmic contacts 163 and 165. A passivation layer 180 is formed on the data lines 171, the drain electrodes 175, and exposed portions of the semiconductors 154. A plurality of contact holes 181, 182, 185a1, 185a2 and 186 is provided at the passivation layer 180 and the gate insulating layer 140, and the contact holes 186 pass through through-holes 176H provided at the expansions 176 of the drain electrodes 175. A plurality of pixel electrodes 190 including subpixel electrodes 190a1, 190a2 and 190b with cutouts 91-95b, a shielding electrode 88, and a plurality of contact assistants 81 and 82 are formed on the passivation layer 180, and an alignment layer 11 is coated thereon.

Regarding the common electrode panel 200, a light blocking member 220, a plurality of color filters 230, an overcoat 250, a common electrode 270 having cutouts 71-76b, and an alignment layer 21 are formed on an insulating substrate 210.

Different from the LCD shown in FIGS. 1-4, the semiconductors 154 and the ohmic contacts 163 of the TFT array panel 100 according to this embodiment extend along the data lines 171 to form semiconductor stripes 151 and ohmic contact stripes 161. In addition, the semiconductor stripes 154 have almost the same planar shapes as the data lines 171 and the drain electrodes 175 as well as the underlying ohmic contacts 163 and 165. However, the semiconductors 154 include some exposed portions which are not covered with the data lines 171 and the drain electrodes 175, such as portions located between the source electrodes 173 and the drain electrodes 175.

A manufacturing method of the TFT array panel according to one embodiment simultaneously forms the data lines 171 and the drain electrodes 175, the semiconductors 151, and the ohmic contacts 161 and 165 using one photolithography step.

A photoresist masking pattern for the photolithography process has position-dependent thickness, and in particular, has thicker portions and thinner portions. The thicker portions are located on wire areas that will be occupied by the data lines 171 and the drain electrodes 175, and the thinner portions are located on channel areas of TFTs.

The position-dependent thickness of the photoresist is obtained by several techniques, for example by providing translucent areas on the exposure mask as well as transparent areas and light blocking opaque areas. The translucent areas may have a slit pattern, a lattice pattern, a thin film(s) with intermediate transmittance or intermediate thickness. When using a slit pattern, it is preferable that the width of the slits or the distance between the slits is smaller than the resolution of a light exposer used for the photolithography. Another technique employs reflowable photoresist. In detail, once a photoresist pattern made of a reflowable material is formed (by using a conventional exposure mask with transparent areas and opaque areas), it is subjected to a reflow process to flow photoresist onto areas without the photoresist, thereby forming an exposure mask with thinned portions.

As a result, the manufacturing process is simplified by omitting a photolithography step.

Many of the above-described features of the LCD shown in FIGS. 1-4 may be appropriate to the LCD shown in FIGS. 6 and 7.

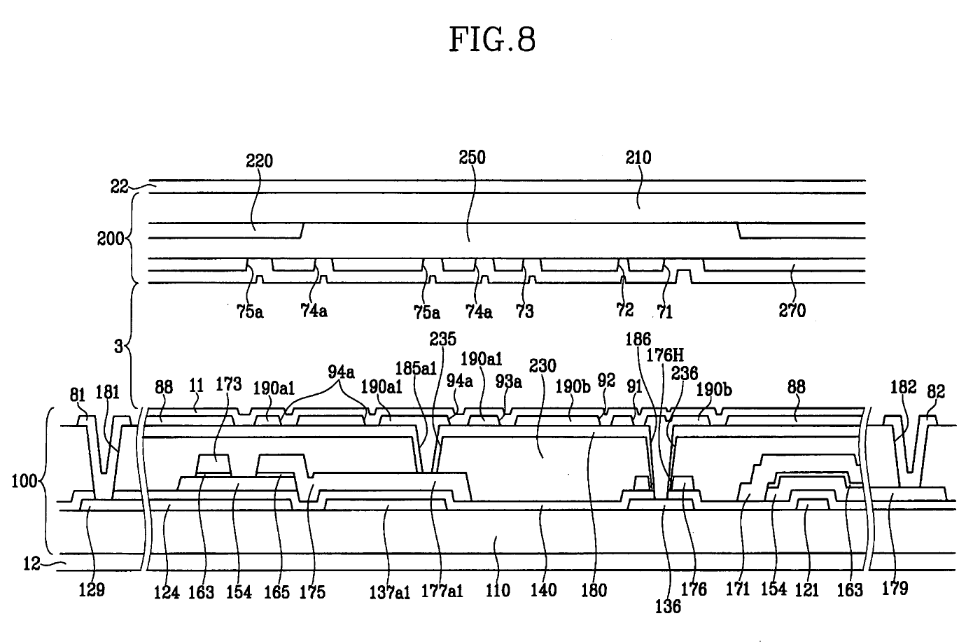

An LCD according to another embodiment of the present invention will be described in detail with reference to FIG. 8.

FIG. 8 is an sectional view of the LCD shown in FIG. 3 taken along line IV-IV′.

Referring to FIG. 8, an LCD according to this embodiment also includes a TFT array panel 100, a common electrode panel 200, a LC layer 3 interposed between the panels 100 and 200, and a pair of polarizers 12 and 22 attached on outer surfaces of the panels 100 and 200.

Layered structures of the panels 100 and 200 according to this embodiment are, in many respects, the same as those shown in FIGS. 1-4.

Regarding the TFT array panel 100, a plurality of gate lines 121 including gate electrodes 124 and end portions 129, a plurality of storage electrode lines 131 including stems 131a1 and 131a2 and storage electrodes 137a1 and 137a2, and a plurality of capacitive electrodes 136 are formed on a substrate 110. A gate insulating layer 140, a plurality of semiconductors 154, and a plurality of ohmic contacts 163 and 165 are sequentially formed on the gate lines 121 and the storage electrode lines 131. A plurality of data lines 171 including source electrodes 173 and end portions 179, and a plurality of drain electrodes 175 including expansions 177a1, 177a2 and 176 and interconnections 178a1 and 178a2 are formed on the ohmic contacts 163 and 165 and the gate insulating layer 140. A passivation layer 180 is formed on the data lines 171, the drain electrodes 175, and exposed portions of the semiconductors 154. A plurality of contact holes 181, 182, 185a1, 185a2 and 186 are provided at the passivation layer 180 and the gate insulating layer 140 and the contact holes 186 pass through through-holes 176H provided at the expansions 176 of the drain electrodes 175. A plurality of pixel electrodes 190 including subpixel electrodes 190a1, 190a2 and 190b and having cutouts 91-95b, a shielding electrode 88, and a plurality of contact assistants 81 and 82 are formed on the passivation layer 180, and an alignment layer 11 is coated thereon.

Regarding the common electrode panel 200, a light blocking member 220, an overcoat 250, a common electrode 270 having cutouts 71-76b, and an alignment layer 21 are formed on an insulating substrate 210.

Different from the LCD shown in FIGS. 14, the TFT array panel 100 includes a plurality of color filters 230 disposed under the passivation layer 180, while the common electrode panel 200 has no color filter. In this case, the overcoat 250 may be removed from the common electrode panel 200.

The color filters 230 are disposed between two adjacent data lines 171 and they have a plurality of through-holes 235 and 236 through which the contact holes 185 and 186 pass, respectively. The color filters 230 are not provided on peripheral areas provided with the end portions 129 and 179 of the signal lines 121 and 171.

The color filters 230 may extend along a longitudinal direction to form stripes and the edges of adjacent two of the color filters 230 may exactly match with each other on the data lines 171. However, the color filters 230 may overlap each other to block light leakage between the pixel electrodes 190, or may be spaced apart from each other. When the color filters 230 overlap each other, linear portions of the light blocking member 220 may be omitted and in this case, the shielding electrode 88 may cover edges of the color filters 230. Overlapping portions of the color filters 230 may have a reduced thickness to decrease the height difference.

The color filters 230 may be disposed on the passivation layer 180, or the passivation layer 180 may be omitted.

Many of the above-described features of the LCD shown in FIGS. 14 may be appropriate to the LCD shown in FIG. 8.

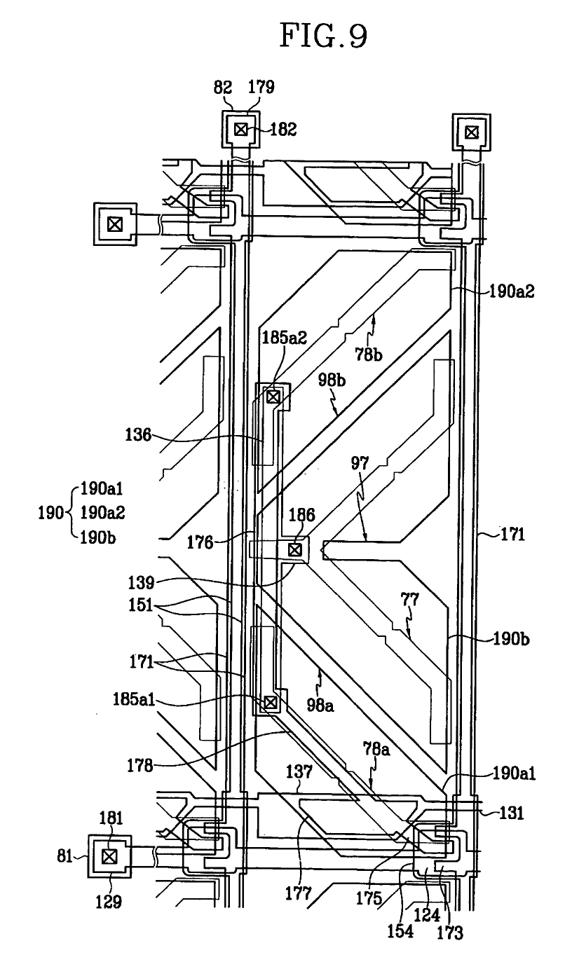

An LCD according to another embodiment of the present invention will be described in detail with reference to FIG. 9.

FIG. 9 is a layout view of an LCD according to another embodiment of the present invention.

A layered structure of an LCD according to this embodiment is almost the same as those shown in FIGS. 14, and thus the section thereof is not shown.

An LCD according to this embodiment also includes a TFT array panel 100, a common electrode panel 200, a LC layer 3 interposed between the panels, and a pair of polarizers 12 and 22 attached on outer surfaces of the panels 100 and 200.

Regarding the TFT array panel 100, a plurality of gate lines 121 including gate electrodes 124 and end portions 129, a plurality of storage electrode lines 131 storage electrodes 137, and a plurality of capacitive electrodes 136 are formed on a substrate 110. A gate insulating layer 140, a plurality of semiconductors 154, and a plurality of ohmic contacts 163 and 165 are sequentially formed on the gate lines 121 and the storage electrodes lines 131. A plurality of data lines 171 including source electrodes 173 and end portions 179 and a plurality of drain electrodes 175 including expansions 177 and coupling electrodes 176 are formed on the ohmic contacts 163 and 165 and the gate insulating layer 140. A passivation layer 180 is formed on the data lines 171, the drain electrodes 175, and exposed portions of the semiconductors 154. A plurality of contact holes 181, 182, 185a1, 185a2 and 186 are provided at the passivation layer 180 and the gate insulating layer 140. A plurality of pixel electrodes 190 including subpixel electrodes 190a1, l90a2 and 190b and having cutouts 97-98b and a plurality of contact assistants 81 and 82 are formed on the passivation layer 180, and an alignment layer 11 is coated thereon.

Regarding the common electrode panel 200, a light blocking member 220, an overcoat 250, a common electrode 270 having cutouts 77-78b, and an alignment layer 21 are formed on an insulating substrate 210.

Different from the LCD shown in FIGS. 14, each of the storage electrodes 131 of the TFT array panel according to this embodiment have only one stem disposed close to a lower gate line 121 and thus a pixel includes only one storage electrode 137.

Each of the capacitive electrodes 136 is elongated parallel to the data lines 171 and includes a projection 139 projecting to right. Each of the drain electrodes 175 includes one expansion 177 overlapping a storage electrode 137, one coupling electrode 176 elongated parallel to the data lines 171 and overlapping a capacitive electrode 136, and an interconnection 178 connecting the expansion 177 and the coupling electrode 176. However, the projection 139 of the capacitive electrode 136 is not covered with the coupling electrode 176 and it is exposed by a contact hole 186. The contact holes 185a1 and 185a2 expose end portions of the coupling electrode 176.

The semiconductors 154 and the ohmic contacts 163 extend along the data lines 171 to form semiconductor stripes 151 and ohmic contact stripes 161.

Each of the pixel electrodes 190 includes only three cutouts 97-98b and is divided into the subpixel electrodes 190a1, 190a2 and 190b by the cutouts 98a and 98b. The cutout 97 extends in the transverse direction and has an inlet from the right edge of the pixel electrode 190, which has a pair of inclined edges substantially parallel to the lower cutout 92a and the upper cutout 92b, respectively.

Similarly, a cutout set 77-78b of the common electrode 270 includes only three cutouts, a center cutout 77, a lower cutout 78a, and an upper cutout 78b. The cutout 78a overlaps the interconnection 178 that may block the light leakage on the cutout 78a.

Many of the above-described features of the LCD shown in FIGS. 14 may be appropriate to the LCD shown in FIG. 9.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A method of repairing a thin film transistor array panel including a gate line, a data line intersecting the gate line, a thin film transistor connected to the gate line and the data line and having a drain electrode, a pixel electrode including at least one first subpixel electrode connected to the drain electrode of the thin film transistor and a second subpixel electrode capacitatively coupled to the first subpixel electrode, the method comprising:
disconnecting the second subpixel electrode or at least one said first subpixel electrode from the thin film transistor.

2. The method of claim 1, wherein the pixel electrode has a cutout overlapping a portion of the drain electrode, and wherein the disconnecting further comprises:
cutting the overlapping portion of the drain electrode.

3. The method of claim 2, wherein the at least one first subpixel electrode comprises a third subpixel electrode and a fourth subpixel electrode, and wherein the disconnecting further comprises:
disconnecting one of the third and the fourth subpixel electrodes from the thin film transistor.

4. The method of claim 2, wherein the at least one first subpixel electrode comprises a third subpixel electrode and a fourth subpixel electrode, and wherein the disconnecting further comprises:
disconnecting the second subpixel electrode and one of the third and the fourth subpixel electrodes from the thin film transistor.

5. The method of claim 2, wherein the disconnecting further comprises:
disconnecting the at least one first subpixel electrode and the second subpixel electrode.

6. The method of claim 2, wherein the thin film transistor array panel further comprises a storage electrode overlapping the pixel electrode or the drain electrode, and wherein the method further comprises:
connecting the disconnected portions of the pixel electrode to the storage electrode.

7. A thin film transistor array panel comprising:
a gate line;
a data line intersecting the gate line;
a thin film transistor connected to the gate line and the data line and including a drain electrode; and
a pixel electrode having at least one first subpixel electrode connected to the drain electrode of the thin film transistor and having a second subpixel electrode capacitively coupled to the at least one first subpixel electrode,
wherein the pixel electrode has a cutout for partitioning the pixel electrode into at least two partitions, the cutout having an overlap portion overlapping the drain electrode, wherein the width of the overlap portion is greater than the width of a remainder of the cutout.

8. The thin film transistor array panel of claim 7, wherein the at least one first subpixel electrode comprises a third subpixel electrode and a fourth subpixel electrode disposed on opposite sides of the second subpixel electrode.

9. The thin film transistor array panel of claim 8, wherein the drain electrode comprises first and second expansions connected to the third and the fourth subpixel electrodes, respectively.

10. The thin film transistor array panel of claim 9, further comprising first and second storage electrodes overlapping the first and the second expansions, respectively.

11. The thin film transistor array panel of claim 10, wherein the first and the second storage electrodes are disposed substantially symmetrical to a reference line approximately bisecting the pixel electrode and approximately parallel to the gate line.

12. The thin film transistor array panel of claim 11, wherein the third subpixel electrode and the fourth subpixel electrode are disposed substantially symmetrical to the reference line.

13. The thin film transistor array panel of claim 11, wherein the drain electrode further comprises interconnections connecting the first and the second expansions.

14. The thin film transistor array panel of claim 13, wherein the interconnections are disposed proximate to the data line.

15. The thin film transistor array panel of claim 7, wherein the drain electrode further comprises a coupling electrode overlapping the second subpixel electrode.

16. The thin film transistor array panel of claim 15, further comprising a capacitive electrode connected to the second subpixel electrode and overlapping the coupling electrode.

17. The thin film transistor array panel of claim 7, further comprising a shielding electrode separate from the pixel electrode and overlapping the data line or the gate line at least in part.

18. The thin film transistor array panel of claim 17, wherein the pixel electrode and the shielding electrode are fabricated within the same layer.
